(19) United States
(12) Patent Application Publication
(10) Pub. No.: US 2015/0073728 A1
(43) Pub. Date: Mar. 12, 2015

(54) PREDICTED CONDITION STATE AND REMAINING SERVICE LIFE OF A MANAGED ASSET

(71) Applicants: JOSEPH KARBARZ, Bloomington, IL (US); Bailey David, Monticello, IL (US); Lance Marrano, Champain, IL (US)

(72) Inventors: JOSEPH KARBARZ, Bloomington, IL (US); Bailey David, Monticello, IL (US); Lance Marrano, Champain, IL (US)

(21) Appl. No.: 13/672,423

(22) Filed: Nov. 8, 2012

Related U.S. Application Data
(60) Provisional application No. 61/557,199, filed on Nov. 8, 2011.

(51) Int. Cl. G01M 99/00; E04D 13/00

(52) U.S. Cl. CPC G01M 99/00; E04D 13/00
USPC 702/34

(57) ABSTRACT

A method of improving a prediction of the remaining service life of a managed asset or a component of said asset by providing an adjusted Condition Index Curve using inspector applied expert knowledge.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Bea Shahin at 217 373-7234.

### BACKGROUND

The proposed invention is an application of expert inspector knowledge incorporated into condition assessment processes and condition prediction methods for use with an engineered management system. The approach described herein was specifically developed for use with the ROOFER sustainment management system, but can be generally applied to any life cycle asset management system. To provide context to the invention's use, novelty, and application, a background on the ROOFER system is described below, along with a discussion of the invention's incorporation.

ROOFER is a sustainment management system (SMS) that combines maintenance engineering concepts with web-based software technology to provide military installations, government agencies, and private buildings owners with a decision support tool for managing roofs. The system provides for computerized, systematic assessment of roof condition, identification of repair and replacement needs, and development of long-range budget requirements to maximize return on investment.

The ROOFER system is comprised of a roof inventory module, and inspection and condition evaluation module, and a roof asset management module for network-level and project-level work identification.

The first step in managing the roof network is to determine the scope of what is being managed. For ROOFER this means developing an inventory of all roofs that the facility manager is responsible for maintaining. The roofs are divided into smaller units called roof sections. A roof section represents the management unit for which all repair and replacement decisions are made. Physical and historical information about each roof section is collected, including the section's physical dimensions, material types for each roof component and construction characteristics.

The inventory provides a structural history of each roof and a record of roof performance that can be used to determine which roof system is most suitable for use on a particular building type or occupancy. It also provides the information needed by engineering personnel to select repair techniques and determine the suitability of replacement systems.

After the inventory data has been collected, the roof is inspected to assess its condition state. To assess condition reliably, ROOFER uses a field-validated objective and repeatable rating system. This structured inspection approach results in the identification of existing roof distresses that adversely affect the performance of the roof system. For each pre-defined roof distress, a deduct value curve has been developed. The curve defines the relationship between the density (calculated measure of amount) of a distress at a particular severity level and the deduct value (FIG. 1). Deduct values are based on a rating scale of zero to 100 with zero deduct value indicating the distress has no impact on failure of the component.

The deduct value curves have been developed, field tested and validated using teams of several roofing experts. Condition ratings based on this methodology have been determined to correlate highly with the mean subjective ratings of the experts.

Using this approach, the membrane, flashing, and insulation are inspected and evaluated independently by identifying individual distresses that are present, providing an accurate assessment of each component's condition, waterproof integrity, and repair needs. The combination of a series of distresses, densities, severities, and defects for a given roof section (FIG. 2) are used to calculate the condition index value (FIG. 3). Individual component condition indexes are used; the flashing condition index (FCI), the membrane condition index (MCI), and the insulation condition index (ICI). These numerical indexes range from 0 for failed to 100 for perfect condition.

The FCI and MCI are determined from a visual inspection of existing roof distresses using established, formalized techniques and procedures. As part of the visual inspection, a survey of the interior and exterior conditions is performed. The condition of the insulation is determined based on an aerial infrared roof moisture survey used to identify areas of wet roof insulation. The amount of the wet area, type of insulation, and the moisture content are used to compute the ICI.

The membrane, flashing, and insulation condition indexes, in total, provide an assessment of the condition of a roof section. By combining these three indexes, a roof condition index (RCI) is produced. This single index is useful for evaluating the overall condition of a roof section at a point in time and for comparing conditions between roof sections.

The inventory and inspection data is loaded into a database using the ROOFER software program. Using the program, the facility manager can perform network management tasks which include determining when individual roof sections should be repaired or replaced (within budgetary constraints), devising strategies to maintain the roof network to meet specified performance levels, and preparing short- and long-range work plans. At the project level, each roof section is evaluated as a candidate work project based on specific distress information collected during the condition inspections. Managers can compare repair and replacement alternatives on a life cycle cost basis to determine the optimal strategy.

### Overview of Service Life Prediction

As stated above, one of the main goals of the ROOFER system to is to determine when and where roof repair and replacements should occur. A significant factor in this determination is the current condition state of the roof, its projected future condition states, and the remaining service life expected.

The roof on a building begins deteriorating shortly after it is applied and the deterioration process continues throughout its life. The rate of deterioration is governed by a complex relationship between the physical characteristics of the roofing material, the natural environment, and the level of maintenance and repair being performed. It is also influenced by the design of the building, the use or misuse of the roof surface, and unusual weather phenomena such as windstorms or hailstorms.

The evaluation of a building's roof system is made on a section by section basis. Selecting between major repair and replacement requires a cost analysis to determine which alternative is more economical. To do this analysis, the projected additional amount of service life obtained by doing repairs must be determined. For a specific roof section, its future rate of deterioration is based partly on its overall condition and its age. This is then used as a means of estimating its expected service life.

Although poorly designed and constructed roofs have been known to fail in less than 2 years, and other roofs have lasted for 30 years or more, the design life of a built-up roof, for example, is generally considered by the roofing industry to be 20 years. For the ROOFER system, a 20-year life was established as “normal.” This assumes that after 20 years the RCI will be in the “Poor” range (26-40). As a result, a “normal” deterioration curve, with the RCI set equal to 33 at an age of 20 years, is shown in FIG. 4 with the bold line.

The deterioration rate and expected life for an actual roof section in service may vary greatly from that of a theoretically defined “normal” 20-year roof, depending on the previously mentioned factors. As a result, a Weibull probability distribution model was developed which represent assets deteriorating at rates different from the “normal” initially assumed rate, for example a 20 year roof as shown in FIG. 4.

U.S. Pat. No. 7,769,568, incorporated herein by reference, details the process for applying the

Weibull probability distribution model for predicting the future condition of a building component using both generalized information about the type of component, as well as specific information about that individual component's actual observed condition over time. In that patent, a mathematical formula is presented, which uses the Weibull cumulative probability distribution function as its basis, but modifies the formula based on key data for the asset management of building components. This formula is provided below:

$$CI ( t ) = A \times {E}^{- {( \frac{t}{beta} )}^{alpha}} \qquad Equation 1$$

### Where:

CI(t)=Condition Index of asset at a point in time, t
A is an initial condition parameter, assumed to be 100 unless a post-install inspection identifies construction defects which indicates the initial condition is something less than 100.
e is the exponential base, 2.718. This is modified slightly to satisfy boundary conditions at the Terminal Condition index, CIₜ.
CIₜ is defined as the condition index at failure, 33 for roofing assets, or 40 for other general building components. Under this provision, e=100/CIₜ, ranging from 2.5 to 3.
t is the independent variable for time, or age of the component, normalized based on its expected design life, DL. t is thus proportional to age or time in service, and t=1 corresponds to the age at the end of its expected service life.
beta is the service life adjustment parameter. Beta greater than 1 means adjusted service life is greater than initially expected, less than 1 means adjusted SL is less than initially expected. Beta is defaulted to 1 unless inspection information is provided.
alpha is the component degradation parameter. An alpha value near 1 indicates nearly straight line deterioration over time. The greater alpha, the more rapidly deterioration accelerates once deterioration becomes noticeable. Alpha is defaulted to 2.64 unless inspection information is provided.

The A, alpha, and beta parameters define the shape and trajectory of the condition index curve over time for a generalized component asset. When no inspection information is provided, these parameters are set to initial defaulted values to reflect the average condition for a family of curves based on a particular component type. See solid line in FIG. 5.

As assessments are performed to observe and measure actual conditions for a specific asset at a point in time, this information is used to adjust parameters and calibrate the curve based on the observed response for that individual asset. See dotted lines in FIG. 5. An inspection in year 2010, for example, could yield a number of different condition index results, with a particular result corresponding to an adjusted service life curve for that component section. U.S. Pat. No. 7,769,568 describes this process.

### Problems with Existing Methods

The deterioration rate (as illustrated in FIG. 5 for example) varies for any type of roof at a specific location as observed by expert analysis and visual inspection. The theoretical deduct values account for a standardized approach as defined in the ROOFER system, to measure current condition states. The approach, however, does not entirely account for localized, environmental factors that result in exceptional deterioration rates, varying service life predictions, and associated repair/replace determinations. This would require multiple inspection observations spread out over time to establish a reliable deterioration pattern in these cases. The ROOFER EMS algorithms are designed to account for average, theoretical roof section performance with repair and replace determinations falling within the norm.

As previously stated, the rate of deterioration is governed by a complex relationship between the physical characteristics of the roofing material, the natural environment, and the level of maintenance and repair being performed over its life. It is also influenced by the design of the building, the use or misuse of the roof surface, and unusual weather phenomena such as windstorms or hailstorms.

As a result, while the theoretical deterioration curves implicitly accounts for location specific dynamic factors such as condition index deduct values, a roof section under study may include additional factors that are not currently captured in the process of a single ROOFER inspection. These factors include boundary conditions such as estimated remaining service life that can only be identified by an expert observer. An improved methodology that accounts for this expert input will result in greater accuracy and reliability of the model.

### BRIEF DESCRIPTION OF DRAWINGS

FIG. 1 depicts ROOFER distress deduct value curve for Blisters.

FIG. 2 describes an assessment of data inputs to calculate a Roof Condition Index (RCI).

FIG. 3 depicts a numerical Condition Index Scale and associated corrective action descriptors.

FIG. 4 shows determination of Deterioration Rate, expected Design Life (DL) and Remaining Service Life (RSL).

FIG. 5 is a graph of Condition Index over time, with multiple possible observed curves.

FIG. 6 shows an adjusted Condition Index Curve using inspector applied expert knowledge.

FIGS. 7A-D represent a Work Item Analyzer Flowchart.

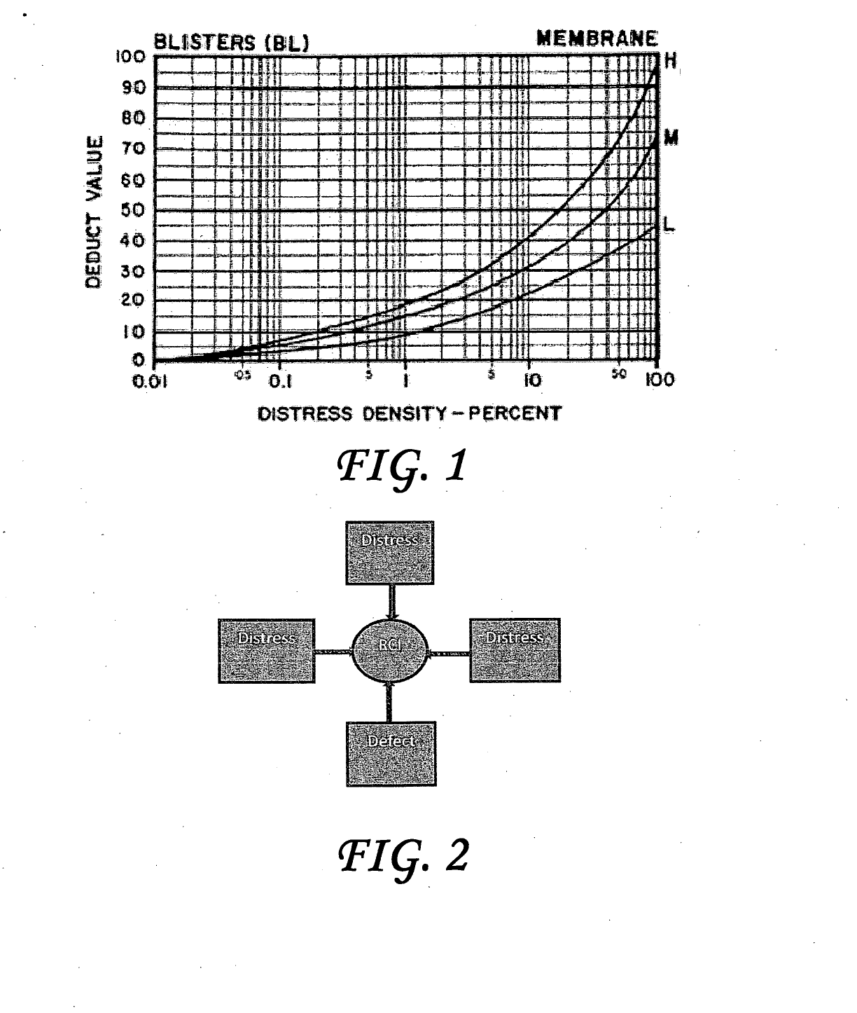

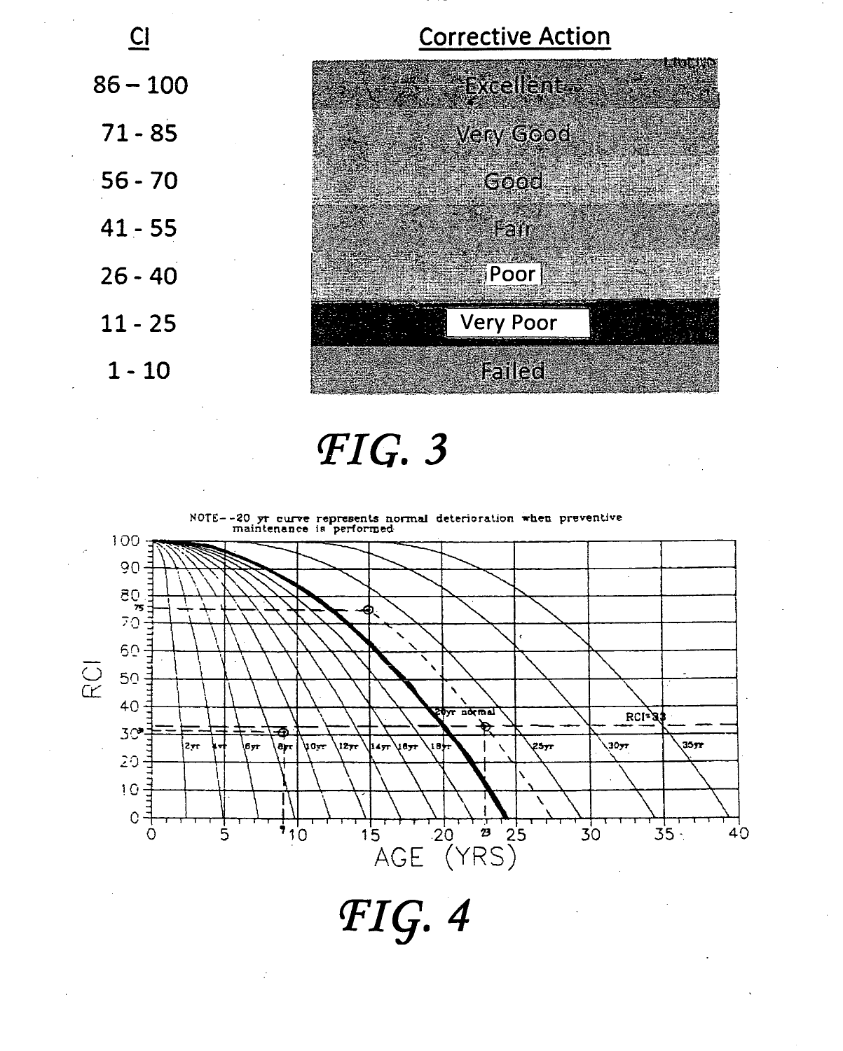

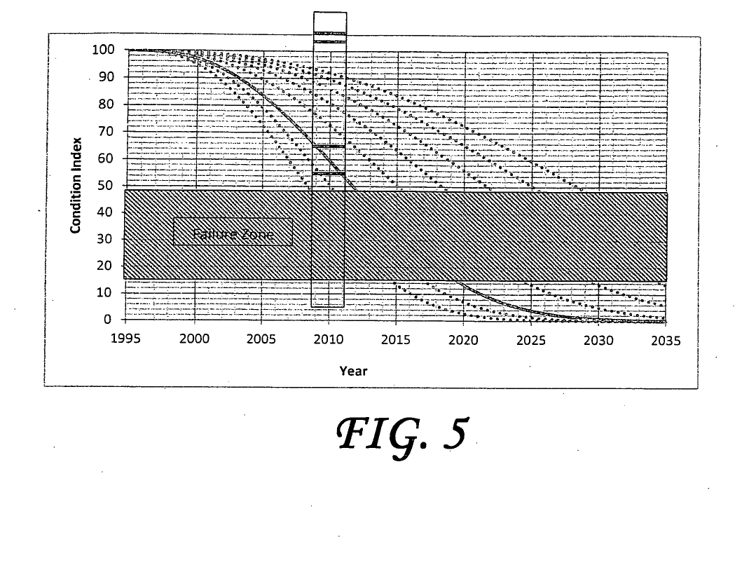

### DESCRIPTION OF INVENTION

This invention is an improvement to the existing algorithm by accounting for the expertise of field personnel. This “inference” algorithm combines human, expert, intelligence, in combination with the engineered management system for a holistic, practical prediction determination.

As mentioned above, U.S. Pat. No. 7,769,568 details the process for predicting the future condition of a building component using both generalized information about the type of component, as well as specific information about that individual components actual observed condition over time.

As assessments are performed to observe and measure actual conditions for a specific asset at a point in time, this information is used to adjust parameters and calibrate the curve based on the observed response for that individual asset.

This adjusted curve uses both accumulated inspection information over time, and the initial estimated design service life to predict an adjusted remaining service life (aRSL) value for the component. However, there are limitations to this approach as discussed above, namely, you need more inspection points to begin defining a reliable deterioration shape which is used to project the component's time to failure.

If during the inspection, the assessor provides (in addition to the measured condition value) an expected remaining service life for that asset based on experience and engineering judgment, this additional and important data element can be used to improve the accuracy of the predicted Condition Index trajectory with less inspection data points. To define this adjusted curve based on the expert RSL (eRSL) input, we set the following parameters from the model discussed above as follows:

$$\begin{matrix}beta = \frac{age + eRSL}{Design Service Life} & Equation 2 \\ alpha = {log}_{\frac{ti}{beta}} ( - {log}_{e} \frac{CIi}{A} ) & Equation 3\end{matrix}$$

### Where:

ti is normalized time at inspection (age at inspection/design service life)
CIi is Condition Index resulting distress based inspection
eRSL=Remaining service life of component provided by inspector expertise

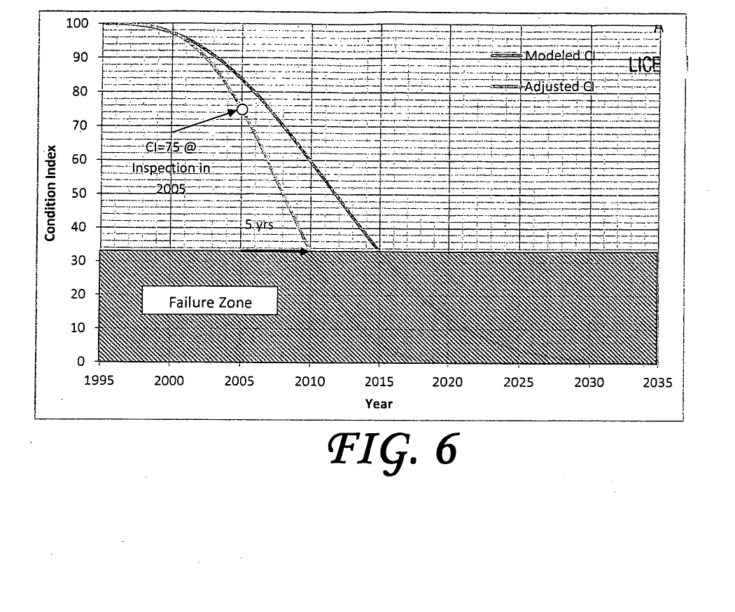

In FIG. 6, the rate of deterioration is adjusted from the initial modeled CI curve based in inspector applied expert knowledge of the roof section remaining service life. In this example, the inspection in 2005 resulted in a condition index value of 75, but expert RSL (eRSL) was given to be 5 years. This improvement allows the condition prediction model to account for additional important data input, and is thus the novel innovation discussed in this patent disclosure.
a. State the advantages of the invention over presently known devices, systems or processes.

This invention is an improvement on U.S. Pat. No. 7,769,568 when used in conjunction with that patent. U.S. Pat. No. 7,769,568 describes the process to modify and calibrate the condition curve based on the observed response from actual measured conditions for a specific asset at a point in time. This invention incorporates additional human intelligence into the knowledge based expert system to represent and apply knowledge electronically. The advantage of the improved predicted service life algorithm is:
1. Predicted service life is based on the subject roof section and reflects the actual performance of the subject roof section.
2. Repair vs. replace determinations are more precise
3. Budget and cost accounting is improved
4. ROOFER reliability is increased.
   b. Discuss the problems which the invention is designed to solve, referring to any prior invention of a similar nature with which you may be familiar.

The algorithms for the ROOFER system assume a normal, theoretical deterioration rate of a roof as it ages. With regular maintenance and repairs, the roof would continue to perform “as if” it were new. This assumption has proved invalid in the field. A roof deteriorates at a rate other than the normal rate after repairs are applied and as the surface material ages. The enhanced predicted remaining service life outlined in this invention disclosure results in a more accurate prediction model.

This algorithm is described for use with a roof asset management system, but is equally applicable to any generalized asset or component having a measurable condition state and finite service life. This includes building components and other civil infrastructure system components.

The improved predicted RSL algorithm integrates sustainment management system technology with knowledgeable, expert visual assessment of roof serviceability. This feature accounts for unknown environmental, physical, material, and maintenance factors into the predicted service life of the roof. This expert opinion not only accounts for location-based factors, but provides for more accurate and reliable prediction roof serviceability. Cost calculations for maintenance, repair, and replacement is significantly enhanced greatly improving the reliability of cost determination results of the system.

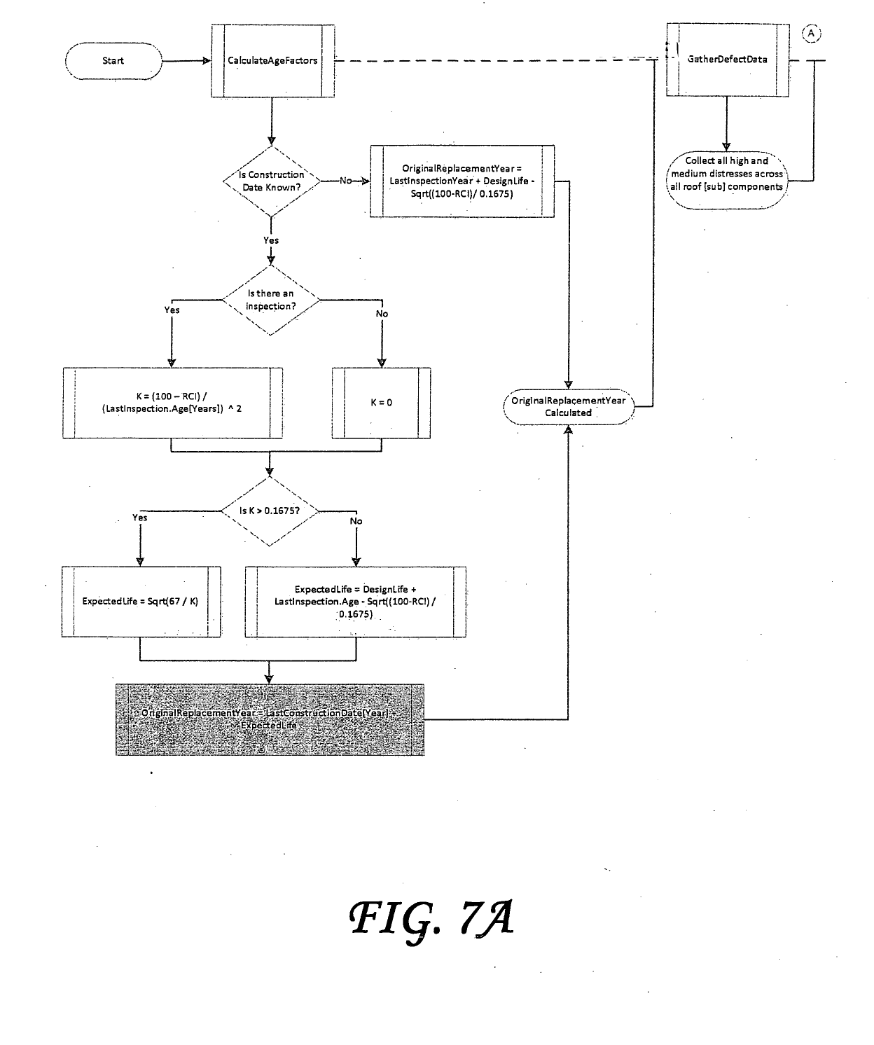

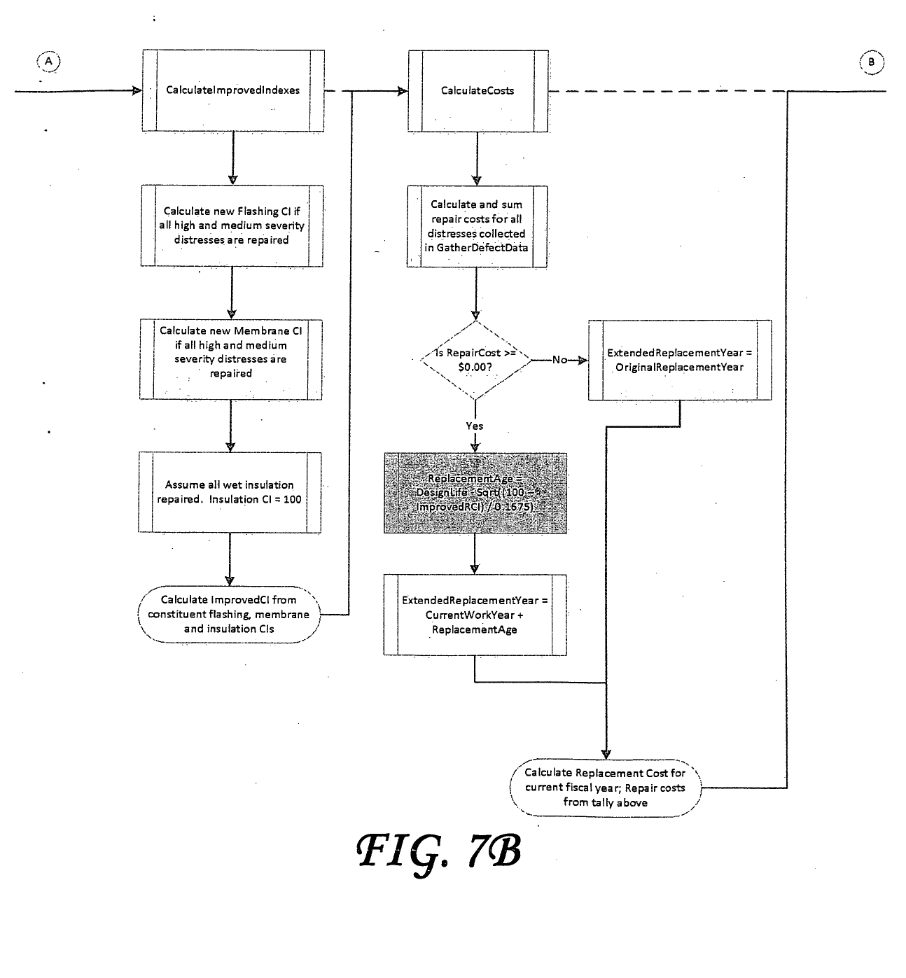

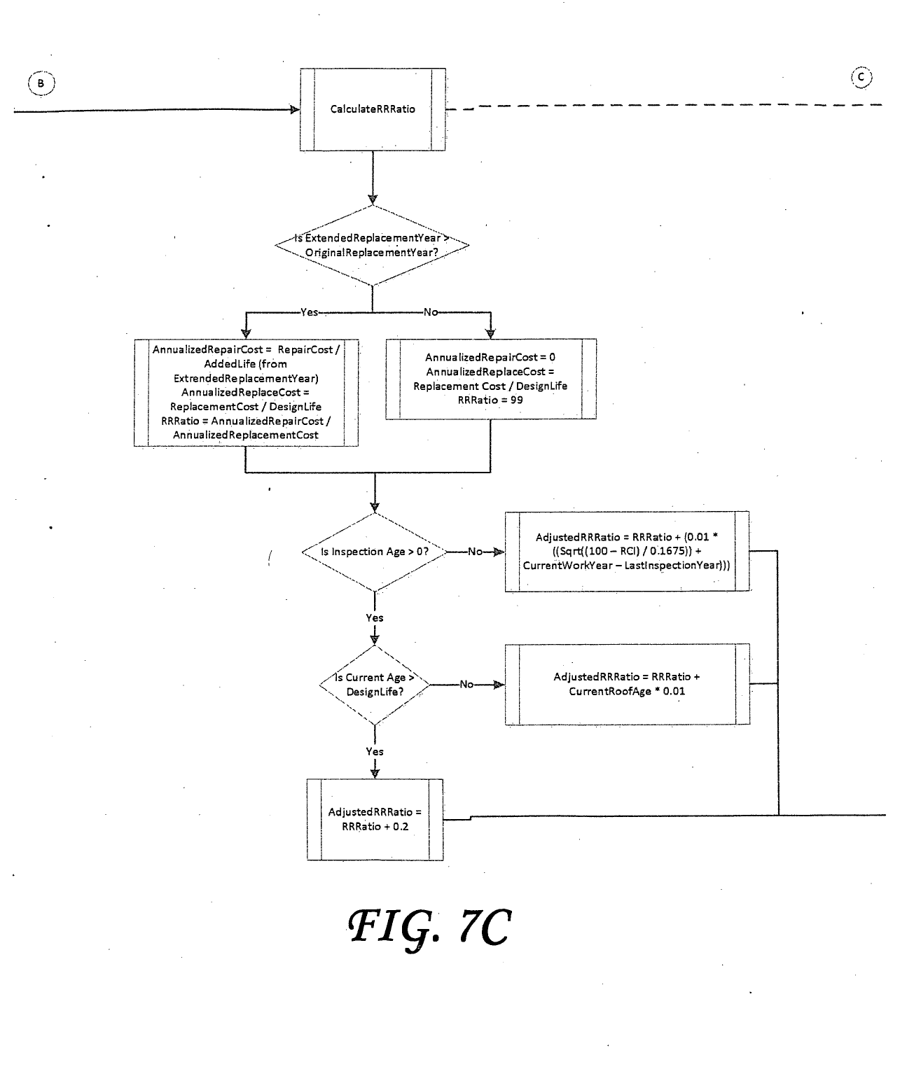

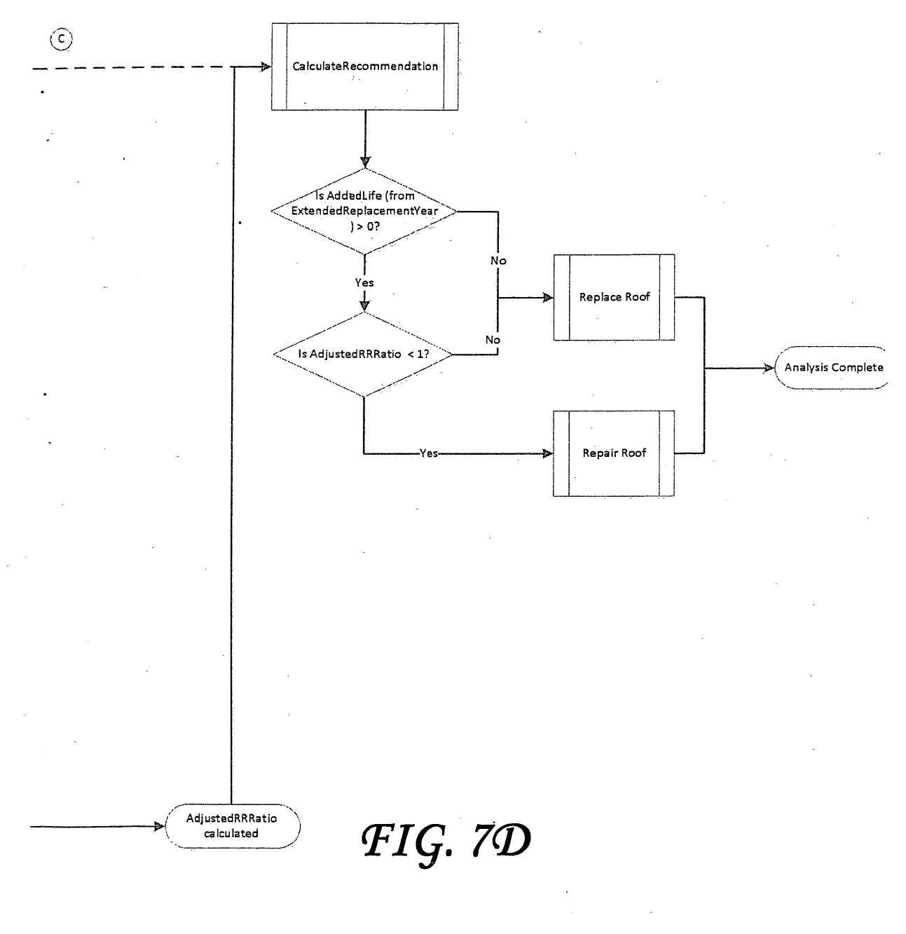

FIGS. 7A-D represent a Work Item Analyzer Flowchart that may be used with select embodiments of the present invention

The abstract of the disclosure is provided to comply with the rules requiring an abstract that will allow a searcher to quickly ascertain the subject matter of the technical disclosure of any patent issued from this disclosure. 37 CFR §1.72(b). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for managing roofs, it may be used for any type of construction and thus may be useful in such diverse applications as pavements, railroads, transcontinental pipelines, marine structures, educational campuses, military installations, and the like. Performance of these structures may be tracked, maintenance scheduled and budgeted, and computer modeling of virtual systems done using select embodiments of the present invention. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

What is claimed is:

1. A method of improving a prediction of the remaining service life of a managed asset or a component of said asset by providing an adjusted Condition Index Curve using inspector applied expert knowledge, said method comprising the steps of:
(i) defining an adjusted curve based on a value for expert RSL (eRSL), the remaining service life of said component or asset obtained by using inspector expertise,
(ii) determining a value for by using Equation 2,
$${β}^{′} = \frac{age + eRSL}{Design Service Life} \qquad Equation 2$$
(iii) determining a value for α by using Equation 3, and
$$α = {log}_{\frac{ti}{{β}^{′}}} ( - {log}_{e} \frac{CIi}{A} ) \qquad Equation 3$$
Where:
ti is normalized time at inspection (age at inspection/design service life)
CIi is Condition Index resulting distress based inspection
A is an initial condition parameter, assumed to be 100 unless a post-install inspection identifies construction defects which indicates the initial condition is something less than 100.
(iv) generating said adjusted Condition Index Curve by using a Weibull cumulative probability distribution function employing said A, eRSL, β′ and α values.
